(19) United States
(12) Patent Application Publication
(10) Pub. No.: US 2015/0142340 A1
(43) Pub. Date: May 21, 2015

(54) DEVICE AND SYSTEM FOR PREDICTING FAILURES OF ACTUATED VALVES

(71) Applicant: ELTAV WIRELESS MONITORING LTD, Raanana (IL)

(72) Inventors: Israel Radomsky, Herzliya (IL); Ohad Gal, Ramat Hasharon (IL); Israel Kalman, Kfar Saba (IL); Moshe Goren, Petach Tikva (IL)

(21) Appl. No.: 14/405,311

(22) PCT Filed: Jun. 6, 2013
(86) PCT No.: PCT/IL2013/050494

§ 371 Date: Dec. 3, 2014

(30) Foreign Application Priority Data
Jun. 7, 2012 (IL) 220262

(51) Int. Cl. F16K 37/00; G01M 3/18

(52) U.S. Cl. CPC F16K 37/0083; G01M 3/184
USPC 702/35

(57) ABSTRACT

The invention relates to a system for determining a potential future failure of an actuated valve controlling fluid flow in a line by causing an angular change between two states of a stem of said valve, which comprises: (a) a sensor for, upon receipt a control command at said actuator, continuously sensing the angular position of the stem, and conveying to a monitoring unit a respective angular variation signal; and (b) a monitoring unit which comprises: (b1) a sampling unit for receiving said angular variation signal, and producing a transition vector which comprises periodical samples from said signal; (b2) a local storage for storing nominal transitional values for said actuator-valve pair; and (b3) a local comparator unit for comparing at least a portion of said transitional vector with the corresponding stored nominal transitional values, and if a difference above one or more predefined threshold values is determined, issuing an alert for a potential failure of said actuator.

### FIELD OF THE INVENTION

The present invention relates to the field of systems and devices for controlling the flow of fluids in chemical industrial facilities. More particularly, the invention relates to a method and system for predicting failures of actuated valves, mainly quarter turn valves in an industrial facility.

### BACKGROUND OF THE INVENTION

In today's industrial environment, systems and equipment must perform at levels thought impossible a decade ago. Global competition is forcing the industry to continuously improve process operations, product quality, yield and productivity with fewer people than ever before. Production equipment must deliver unprecedented levels of reliability, availability, and maintainability as plant managers seek ways to reduce operational and support costs and to eliminate or minimize capital investments. In short, industry must invoke new measures to improve production, performance, and safety while minimizing costs and extending the operational life of new and aging equipment.

Although the term “quarter turn valve” is used in this application, and the examples that are given mostly relate to quarter turn valves, the invention is not limited for use only with this type of valves, but essentially with any type of actuated industrial valve.

Fluid lines are widely used in almost every industrial facility. The fluid flow in the lines is generally controlled by means of valves. Quarter turn valves, in view of their simple structure and relatively low cost, are widely used in the fluid control. Most of the valves are operated manually, but high priority valves at key locations are controlled automatically by an actuator attached to them.

Quarter turn valves and actuators comprise moving elements, and they are exposed to harsh environmental conditions. A failure of a quarter turn valve actuator may result in a very significant damage. Besides the fact that replacement of the quarter turn valve may take from 1 hour and up to several weeks during which the process is generally shut off, a failure may also cause intolerable damage to the product of the process, until the failure is detected and fixed. Therefore, in view of their important role in the process, actuators are in many cases replaced after a predetermined duration of working period, or after a predetermined number of activations, irrespective of their actual condition. However, even when such a practice is applied, there are still many cases of actuator failures that result in significant damages. The present invention predicts such failures on time, when it is still possible to activate corrective measures that minimize damages.

WO 2008/078323 by same applicant discloses a wireless network system for monitoring quarter turn valves within an industrial facility, which comprises (a) plurality of battery operated, add-on wireless valve monitoring devices (VMDs), wherein each VMD is affixed externally to an existing quarter turn valve, and comprises: (b) a sensor for sensing the angular position of the quarter turn valve; (c) short range wireless communication unit for transmitting at least immediately upon sensing any change in said quarter turn valve angular position a status message which includes the new angular position of the quarter turn valve as sensed by said sensor and an identification of said VMD; (d) mechanism for affixing the add-on VMD to the monitored quarter turn valve in a manner which does not disturb the normal operation of the quarter turn valve; and (e) one or more Valve Device Readers (VDRs) located a short range from one or more of said VMDs for receiving said status messages, and for forwarding the same to a server by Ethernet communication.

The system of WO 2008/078323 is applicable for wirelessly monitoring quarter turn valves that are remotely activated by means of an actuator, as well as for quarter turn valves that are manually operated.

It is an object of the present invention to increase the reliability of automatic systems for controlling quarter turn valves, i.e., those systems that utilize actuators for the automatic control of quarter turn valves.

It is still another object of the present invention to reduce the maintenance periods in said automatic control systems, and as a result to increase the operational period of those systems.

It is a more specific object of the present invention to detect a failures of an actuator of a quarter turn valve at its very early stage, when the failure just begins to develop, and before any damage occurs. In other words, it is an object of the present invention to forecast failures of quarter turn valve actuators.

Other objects and advantages of the present invention will become apparent as the description proceeds.

### SUMMARY OF THE INVENTION

The invention relates to a system for determining a potential future failure of an actuated valve controlling fluid flow in a line by causing an angular change between two states of a stem of said valve, which comprises: (a) a sensor for, upon receipt a control command at said actuator, continuously sensing the angular position of the stem, and conveying to a monitoring unit a respective angular variation signal; and (b) a monitoring unit which comprises: (b1) a sampling unit for receiving said angular variation signal, and producing a transition vector which comprises periodical samples from said signal; (b2) a local storage for storing nominal transitional values for said actuator-valve pair; and (b3) a local comparator unit for comparing at least a portion of said transitional vector with the corresponding stored nominal transitional values, and if a difference above one or more predefined threshold values is determined, issuing an alert for a potential failure of said actuator.

Preferably, said comparison of at least a portion of said transitional vector relates to the total period for transition between said two end states of the quarter turn valve, and wherein if a difference above a predefined threshold value is determined following said comparison, a first type of alert is issued.

Preferably, the transitional vector is conveyed to the control center, which in turn comprises: (a) a remote storage for storing full-vector nominal transitional values for said actuator-valve pair; and (b) a remote comparator for comparing said transitional vector with corresponding stored nominal transitional values, and if a difference above one or more predefined threshold values is determined, issuing a second type alert for a potential failure of said actuator.

Preferably, the system further comprises storage for said threshold values.

Preferably, said comparator is made of plurality of comparator elements.

In another aspect, the invention relates to a method for predicting a failure in an actuator for a quarter turn valve, which comprises: (a) storing nominal transitional values describing the rate of angular change of a stem of said quarter turn valve during activation by said actuator; (b) upon activation of the quarter turn valve by said actuator, obtaining a transitional vector which describes the rate of angular change of said stem during activation; and (c) comparing said transitional vector with at least a portion of said nominal transitional values, and when determining a difference above a predefined value, concluding that a failure exists or is expected to occur.

### BRIEF DESCRIPTION OF THE DRAWINGS

In the drawings:

FIG. 1 illustrates a prior art actuator-valve set;

FIG. 2 illustrates a prior art actuator-valve set, together with a general block diagram describing the manner of its actuation;

FIG. 3 shows an example for an actuator-valve pair, which is provided with an add-on VMD (Valve Monitoring Unit);

FIG. 4 shows an exploded view describing the installation of a VMD on an actuator-valve set;

FIGS. 5a to 5f show various transitional curves for actuator-valve sets that are in order, as well as for actuator-valve sets having failures; some of the said latter curves relate to failures at their very beginning stage of the failure development;

FIG. 6 provides a block diagram which illustrates the general operation of the monitoring system according to an embodiment of the present invention; and

FIG. 7 illustrates in a block diagram form the basic structure of the monitoring unit, according to an embodiment of the invention.

### DETAILED DESCRIPTION OF PREFERRED EMBODIMENTS

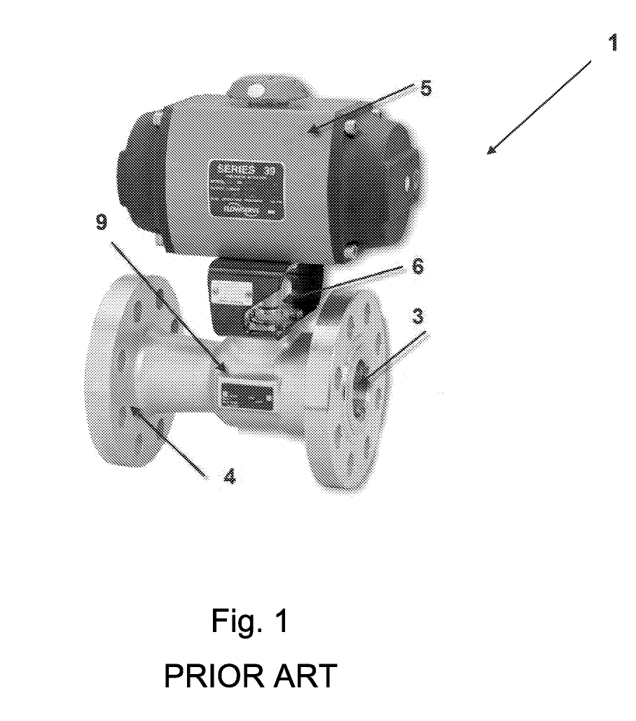

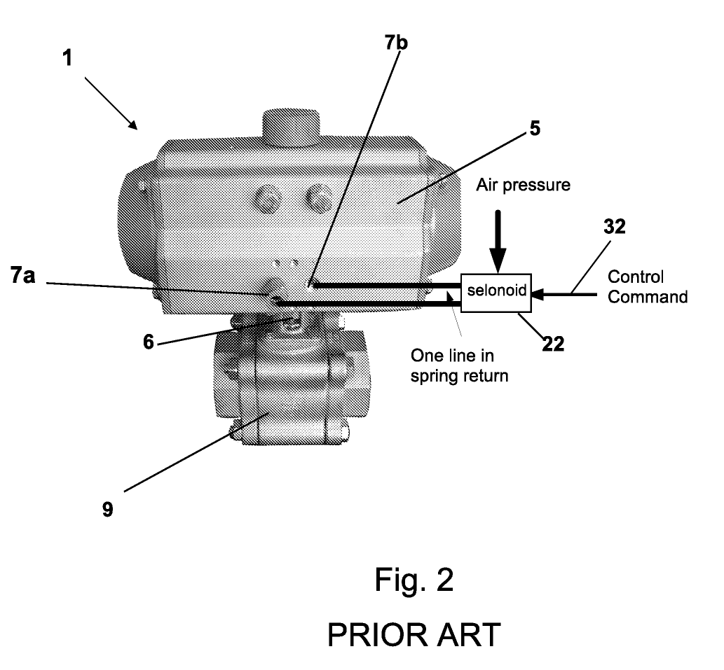

FIGS. 1 and 2 illustrate the structure of a typical quarter turn valve actuation system 1, such as widely used in the industry for controlling the flow of fluids. Quarter turn valves 9 (two slightly different versions of quarter turn valves are shown in FIGS. 1 and 2 respectively) are typically sized between ½″ to 12″. The quarter turn valve 9 is installed between two sections of a fluid or a gas line, and in most cases it serves as an OPEN/CLOSE flow switch. However, there are still cases where the quarter turn valve is positioned at a selected angular position in between said OPEN and CLOSE states. This type of valve is called a Control Valve. Quarter turn valve 9 essentially comprises a hollow section (not shown), an inlet 3, an outlet 4, and a stem 6 which connects the valve 9 to an actuator 5. Air pressure delivered to an air inlet 7a (shown in FIG. 2) actuates the valve by moving internal pistons that in turn rotate the valve's quarter turn. After the activation of actuator 5 it can be returned to the initial position by another air pressure 7b supplied to an internal piston, or by an internal return spring (not shown).

FIG. 2 also illustrates the typical interaction between a typical actuator 5 and a quarter turn valve 9. When a need arises to change the state of the quarter turn valve 9, a control command 32 is conveyed from a remote location (such as a control computer at the control room) to the actuator 5. The control command may be in a form of a fluid pressure (hydraulic or pneumatic), or in a form of an electric signal. Control command 32 provides indication to actuator 5 in terms of the direction and magnitude of a desired angular change. In the case of a hydraulic or pneumatic command, the electric commands 32 from the control room are delivered to solenoid 22 which in turn supplies air pressure for moving the actuator 5. For example, in the case that quarter turn valve 9 is designed to operate between two CLOSE and OPEN states, the angular change of the quarter turn valve stem 6 may be 90°. In that case, two stoppers are typically provided at respective end locations of the valve or its stem 6 to accordingly limit the rotation of stem 6. The actuator 5, in response to said control command 32, applies during some period a rotational force on stem 6 of quarter turn valve 9. In response to said angular force, stem 6 rotates within some angular range and direction to respectively change the state of the quarter turn valve 1. As noted above, the change of state may be a full or partial opening or closure of quarter turn valve 9. In some cases, two lines of air pressure are delivered to actuator 5, one for causing a clockwise rotation, and the other for causing a counterclockwise rotation. In other typical case, the air pressure may rotate the actuator 5 in one direction, while a spring returns it backward.

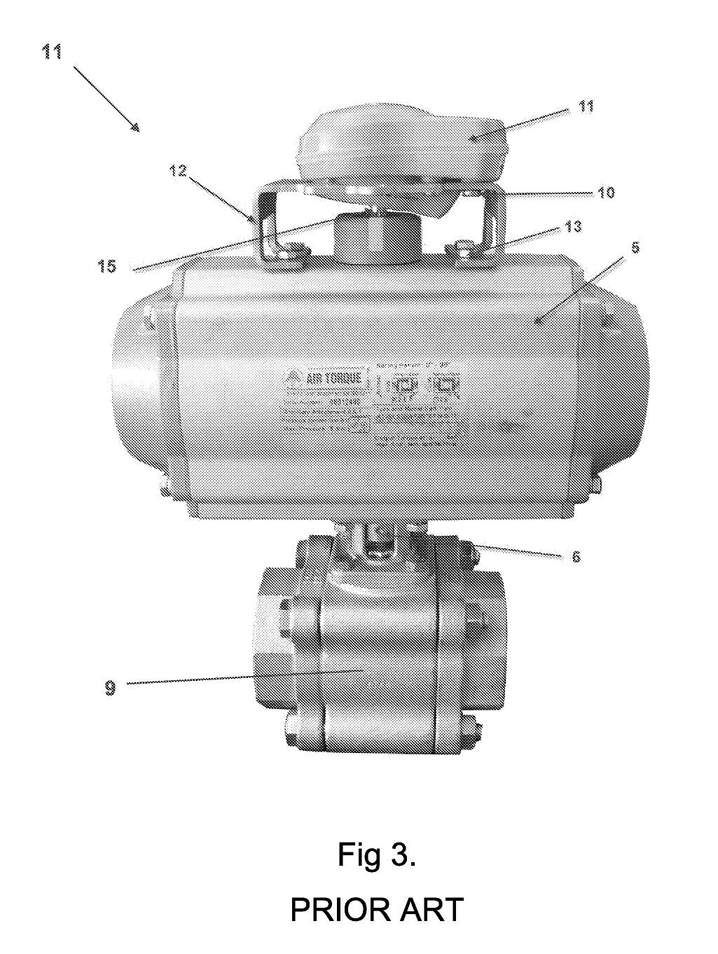

Said WO 2008/078323 also discloses a short-range wireless quarter turn Valve Monitoring Device (“VMD”) which can be installed, for example, on an actuated quarter turn valve. In a preferred embodiment of WO 2008/078323, the VMD is an add-on device, which is adapted to be easily installed on an existing actuator even when said actuator is operative. FIG. 3 shows an example for the installation of such an add-on VMD in a system 11. Initially, a U-shaped supporting element 12 is attached to the existing body of actuator 5 by one or more screws 13. Valve Monitoring Device 16 is attached by means of screws 10 to a top portion of the supporting element 12. In such a manner, the supporting element 12 and the Valve Monitoring Device 16 do not disturb the normal operation of actuator 5. The VMD 16 comprises a sensor (not shown in FIG. 3) for reading the status (i.e., angular position) of actuator 5, and a communication unit (not shown) for periodically, or upon request or event transmitting the status of the actuator and the identification number of the VMD to another device located within the communication range of said VMD. Said another device may be, for example, a short range device such as a Valve Device Router—VDR, as elaborated in WO 2008/078323.

There are various manners by which the reading of the status of the actuator is performed by the VMD 16, all are elaborated in WO 2008/078323. The VMD 16 is preferably battery powered (typically about 5 years of battery life) and uses wireless protocol such as 802.15.4, ZigBee, ISA100.11a, WirelessHart 2.4 GHz, or any other wireless frequency range or protocol capable of wirelessly communicating messages. A sensor within VMD 16 measures the angular position of the VMD shaft 15 (in fact, also the angular position of the stem 6) in degrees relative to the body of actuator 5. The VMD 16 of WO 2008/078323 reports the valve status after it senses a move of the stem 6, and possibly also every predetermined time, for example, once every 15 minutes.

Still with reference to FIG. 3, the sensing of the angular position of the quarter turn valve stem 6 may be performed in various manners, some of them are discussed in WO 2008/078323. For example, shaft 15 may be attached to a potentiometer directly or through a gear spur, and said potentiometer position provides an indication with respect to the angular position of the actuator stem 6.

As noted, said VMD 16 of WO 2008/078323, among other features, determines the angular state of the actuator at any given time, and when a change occurs, it reports this change to a remote location.

As will be elaborated, according to the present invention the VMD 16 is modified to have the capability of detecting at a very early stage the development of an actuator failure, namely, at a stage when the failure just begins to develop. This is performed by means of analyzing the manner of movement of stem 6.

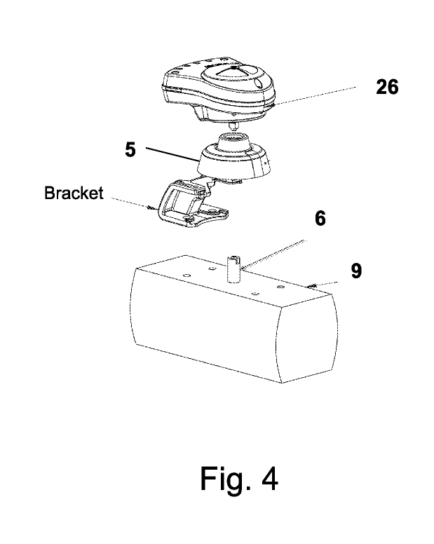

FIG. 4 is a general exploded view of an actuator system 21 according to an embodiment of the present invention. The actuator system 21 is enhanced compared to the system of FIG. 3 to detect failures at their early development stage. More specifically, Enhanced Valve Monitoring Unit (EVMD) 26 receives an angular variation signal from internal angle sensor, determines a transition vector from said signal which relates to the interaction between the actuator 5 and the quarter turn valve 1, and reports to a remote location both the state of the quarter turn valve 5 and said determined transition vector. The transition vector comprises samples of transitional stem 6 states that have been extracted by the EVMD 26. The transitional states are extracted at predefined sampling times, for example, periodically during the movement of stem 6 between its two respective states. More specifically, upon receipt of each control command 32, the EVMD 26 measures periodically the exact angular location of the stem 6 at plurality of sampling times during the movement of the stem 6 between the two respective states as defined by the control command 32 (shown in FIG. 3). As will be shown, the system 21 of the present invention can determine not only if the control command 32 which is provided to actuator 5 is actually performed, but it also can detect developments of actuator failures at their very early stages.

The actuator system 21 of the present invention is based on several observations, as follows:
a. When an actuator is in order, it should perform the defined angular rotation change (for example from a closed state to an open state) within a nominal period. Specifications of actuators typically provide indications to this period, when used with various types of quarter turn valves, and at various operations situations.
b. It has been found that when an actuator changes a state of a quarter turn valve, the angular change of the valve's stem with respect to time is essentially linear during the whole transition period between the two states, or at least the angular transition curve is well defined.
c. At the initial stage of an actuator fault, when the fault just begins to develop, the rate of the angular change of the stem during the transition begins to divert from said well defined curve. The EVMD of the present invention monitors this transition curve, and when a diversion from the nominal curve above a predefined threshold is detected, the EVMD issues an alert notifying that a failure begins to develop.

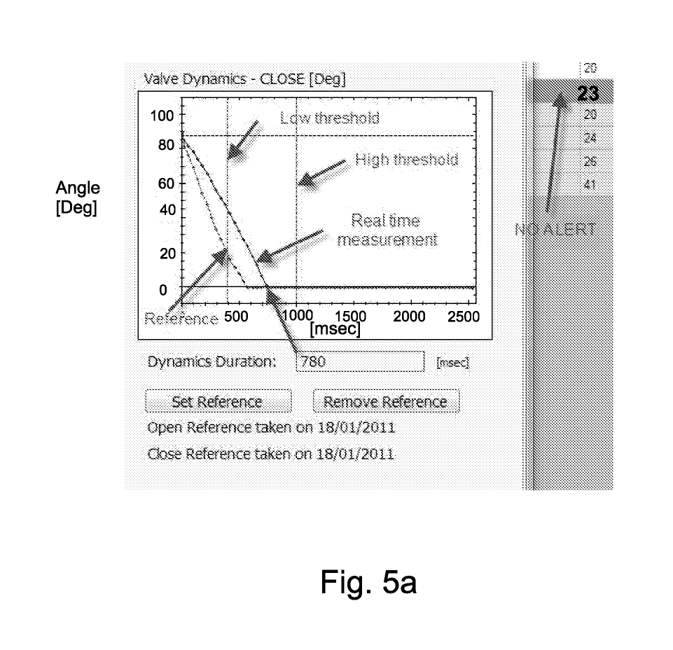

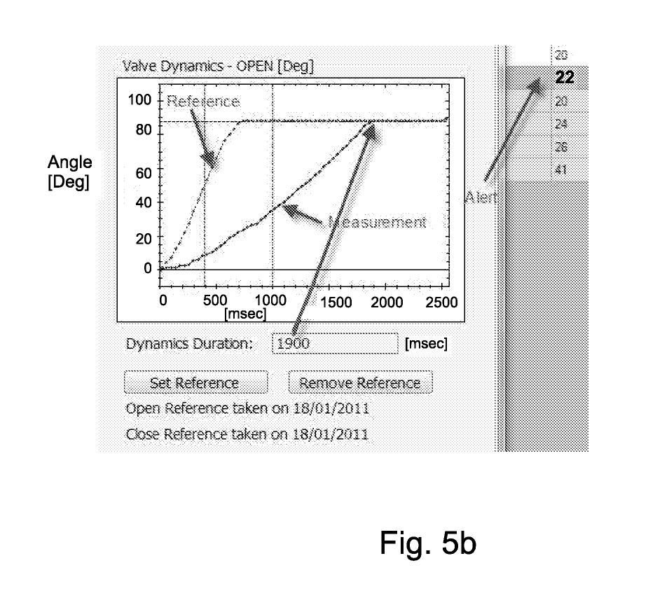

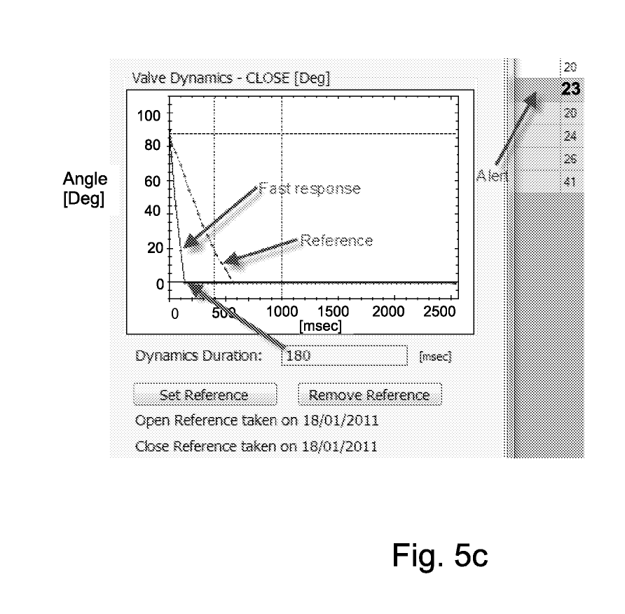

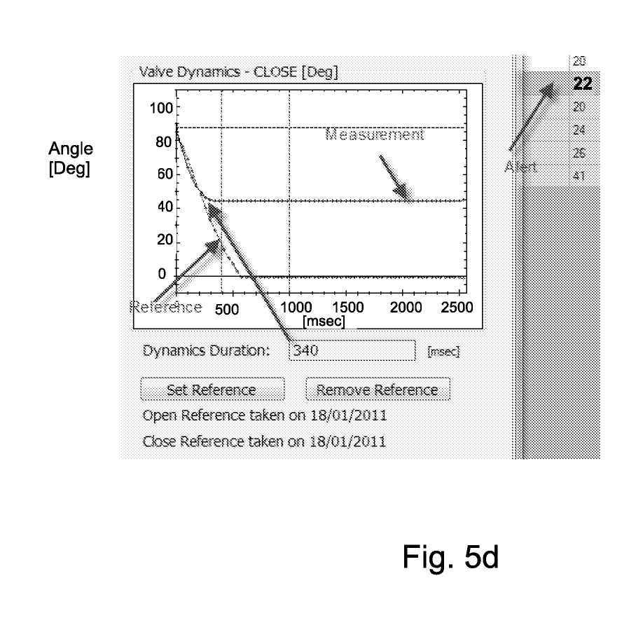

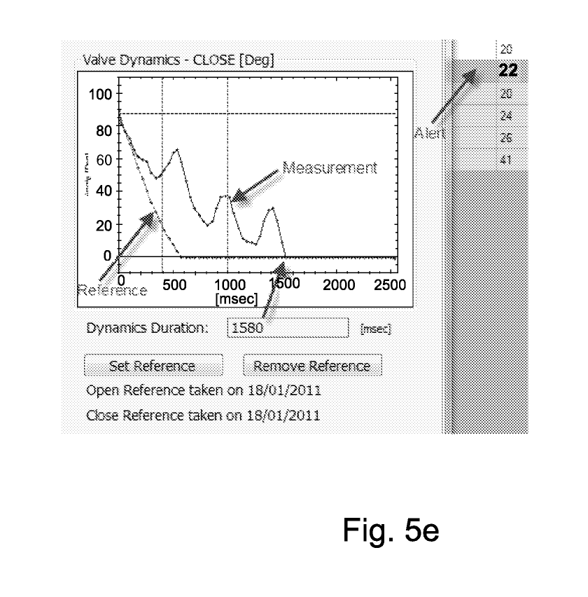

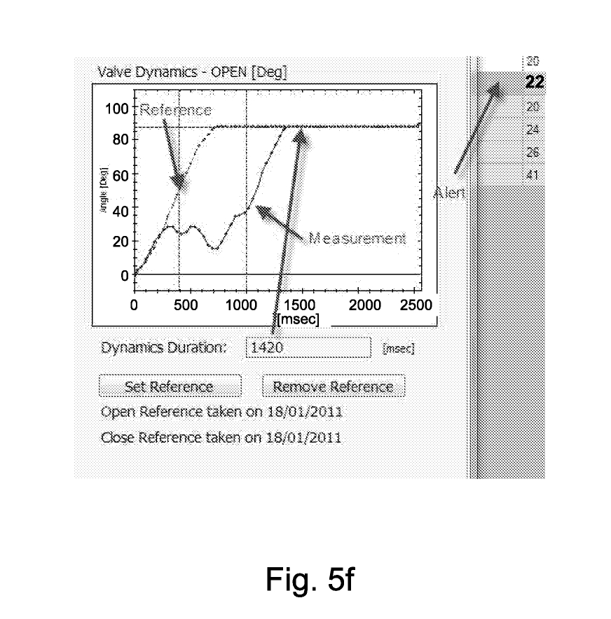

The diagram of FIG. 5a illustrates a typical transitional curve of an actuator-quarter turn-valve system, assuming that the quarter turn valve is in order. More specifically, the diagram illustrates a transitional curve from a closed state to an open state of the quarter turn valve. The Y axis of the diagram shows the transition in degrees, while the X axis indicates the time passed. It can be seen that this transitional curve is essentially linear. The diagram shows the minimal transition time (400 ms) and the maximal transition time (1,000 ms), that are derived from the valve-actuator set specification. The diagram also shows a reference response line, and the real response line that was measured in practice. It can be seen that the actual response is also linear, and that the transition time of the particular set was 780 ms, which is still within the expected limits for an in-order set.

FIG. 5b is a diagram similar to FIG. 5a, which illustrates a typical transitional curve of a valve-actuator set, where a failure exists. The diagram shows that the movement of the valve-actuator set was slow, took about 1900 ms which is beyond the upper threshold for the transition time. This indicates that the set is faulty and needs replacement or repair (probably damaged O-rings or debris inside).

FIG. 5c is a diagram similar to FIG. 5a, which illustrates a typical transitional curve of a valve-actuator set where a failure exists. It can be seen that the duration of the movement of the valve-actuator set was 180 ms, i.e., faster than the reference and under the lower threshold. This measurement indicates that a failure exists, most probably the shaft between the actuator and the valve is broken (no mechanical load for the movement).

FIG. 5d is a diagram similar to FIG. 5a, which illustrates a typical transitional curve of a valve-actuator set where another failure exists. It can be seen that the movement of the valve/actuator set was stopped at midway. This indicates that most probably there was too much mechanical resistance to the valve movement, or there was not enough air pressure to drive the actuator, hence the rotational process stopped midway.

The diagram of FIG. 5e illustrates still another transitional curve of a failed valve-actuator set. the diagram shows that the movement of the valve-actuator set was jumpy all the way. This may be an indication for a faulty air pressure sealing system at the actuator (for example, damaged O-Ring). Other causes for such a failure may be: (a) debris within the actuator or the valve; (b) the air supply is unsteady, therefore, the rotational process of the actuator-valve set is not continuous.

The diagram of FIG. 5f illustrates still another transitional curve of a failed valve-actuator set. It can be seen that the beginning of the movement was non-faulty, but later on, the rotational movement stopped, even retreated back, and was jumpy until it finished its rotation. This most probably is an indication for a faulty sealing of the air pressure to the actuator (damaged O-Ring). Other reasons for the failure may be debris within the actuator or the valve starting at some angle, unsteady air supply which causes the rotational process of the actuator-valve set to be non-continuous and non-monotonous.

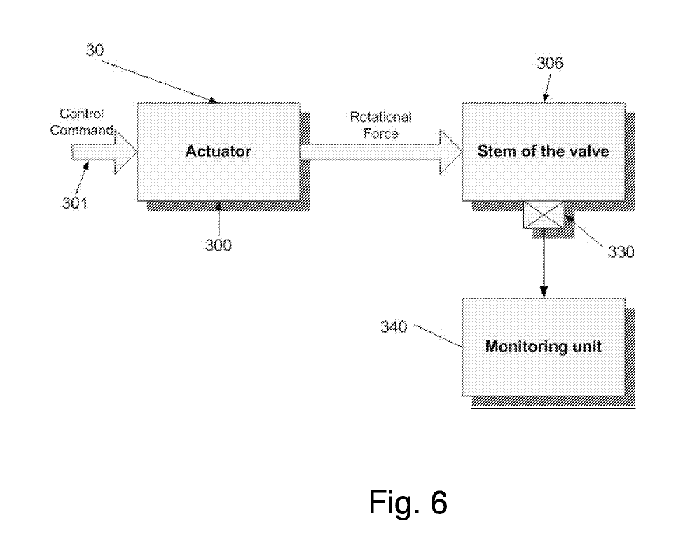

FIG. 6 is a block diagram illustrating the general operation of the monitoring system according to an embodiment of the present invention. A control command 301 is provided to actuator 300, indicating a desired angular change the valve stem. The actuator effects this angular change, while sensor 330 senses and conveys to monitoring unit 340 the angular variation signal. More specifically, said angular variation signal indicates the quarter turn valve stem angular position with respect to time (i.e., the angular change of the stem). Monitoring unit 340 periodically samples said variation signal, and produces a transition vector, which contains all the samples in terms of time. This sequence, or a portion thereof, is then compared with pre-stored nominal values, and if a diversion above a predefined threshold is found, a suitable alert is issued. The one or more comparisons may be performed either within the monitoring unit 340, or at the control center to which the transition vector is conveyed. The following two comparisons are preferably performed by the system of the present invention:
a. A comparison between the measured total transitional period and a corresponding pre-stored total nominal value. Diversion above a predefined value forms an indication for a developing failure of actuator 300. Preferably this comparison is performed at the monitoring unit 340, which is located at the actuator and quarter turn valve location. In that case, a first type of alert relating to this failure is transmitted from the monitoring unit 340 to the control center (not shown).
b. A series of comparisons between the discrete plurality of samples and corresponding pre-stored discrete nominal values. If one or more diversions above a predefined value are detected as a result of these comparisons, a second type of alert is issued. Typically, the second type of alert hints that an actuator failure develops. Preferably, this full comparison of the transitional vector (with the corresponding pre-stored values) is performed at the control center (i.e., as a series of separate comparisons for each sample respectively). It should be noted that the control center preferably performs such a vector comparison essentially following each control command 301.

The comparisons as elaborated above can provide very important indications with respect to the functionality of the actuator-valve set. As mentioned, it has been found that the system of the present invention can detect actuator or valve failures at their very initial stage of development, and before the failure causes any damage to the process or the product. Such initial-stage actuator-valve failures cannot be observed by any conventional means of the prior art.

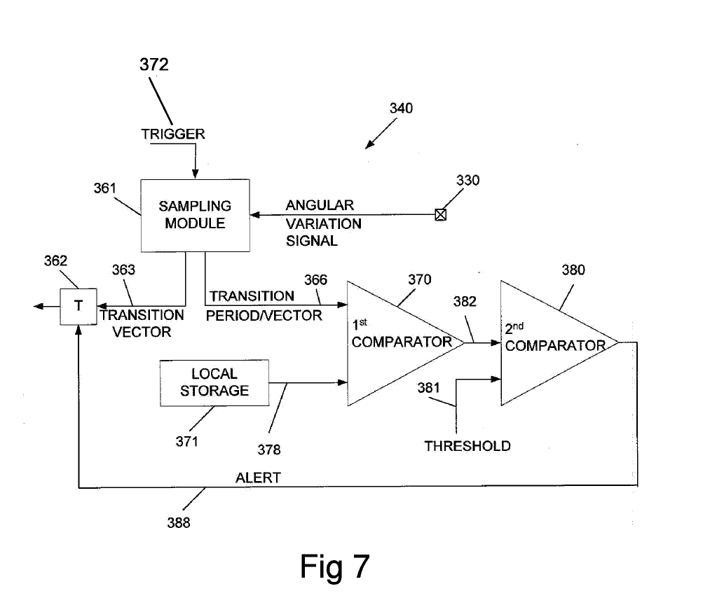

FIG. 7 illustrates in block diagram form the basic structure of monitoring unit 340. Upon receipt of a control signal 301 (see FIG. 6), a trigger is issued at the monitoring unit 340, or is received from the actuator. This trigger marks the beginning of the sampling, as well as the beginning of the transition period. Therefore, starting from the moment of the trigger, sampling module 361 begins to sample in terms of time the angular position of the stem, as sensed by sensor 330. The sampling module 361 produces a transition vector. The transition vector (output 363 of the sampling module 361) is typically conveyed to the control center via transmitter 362 for verification and for possibly issuing a second type of alert. In a first embodiment, the period between the two end points of the stem (i.e., the period it takes for completion of the transition) is provided via output 366 to a first input of 1^{st} comparator 370. Local storage 371 provides the pre-stored nominal value for said period into the 2^{nd} input 378 of 1^{st} comparator 370. Said 1^{st} comparator outputs the difference between said nominal and measured periods into a first input 382 of 2^{nd} comparator 380. The second input 381 of the 2^{nd} comparator 380 receives a predefined threshold. If the difference between the first and second inputs 382 and 381 respectively of the 2^{nd} comparator is found to be positive (i.e., input 382 is found to be above the threshold), a first type of alert is issued at output 388, and sent to the control center via transmitter 362. Otherwise, if input 382 is below the threshold, the actuator is determined as being in-order.

According to a second embodiment of the invention, the monitoring unit performs full transition vector verification. In that case, sampling unit 361 sequentially outputs (i.e., one-by-one) the full vector into the first input 366 of the 1^{st} comparator 370. Local storage 371, in turn, maintains full vector nominal values, and outputs sequentially (one by one) corresponding nominal values into second input 378 of the 1^{st} comparator 370. The comparison operations by said two comparators 370 and 380 are the same as in said first embodiment; however, pluralities of comparisons are now performed separately with respect to each sample of the transition vector. A second type of alert is now issued at output 388, and is sent to the control center.

When the monitoring unit 340 is designed to operate according to said first embodiment (i.e., for the detection of only first type of alert), the full vector is sent to the control center (output 363 of the sampling unit). In that case, the full vector verification is performed at the control center (and not within the monitoring unit 340) substantially in the same manner as described with respect to the second embodiment above. This manner of operation is somewhat advantageous, as the monitoring unit needs a less sophisticated processor, and a smaller storage size. Moreover, in said latter case the control unit can perform verifications with respect to plurality (even many) of actuators, using the same software and same stored data (as long as same pair (set) of actuator-valve is used).

According to the present invention, the number of samples for each transition may vary. For example, the number of samples during one transition may be in the range of between 3 and 100.

Several typical failures that can be detected by the system of the present invention have been observed:
a. Incompletion of the angular stem path: For example, a control command for the closure of the quarter turn valve is conveyed to the actuator. The actuator in turn tries to close the quarter turn valve. However, due to a failure of the actuator, the stem does not complete its full path. As a result, a “completion period” of essentially infinity is detected, and at least a first type, and possibly also a second type, of alert is issued.
b. Completion of the path faster than expected: There are cases where the stem breaks to two pieces, an upper stem piece which is connected to the actuator, and a lower stem piece which includes the valve. In that case, although the actuator rotates and the upper portion of the stem “completes” its angular path, the valve itself in fact remains stationary. In that case, the “completion” of the path is found to be faster than the nominal, in view of a lack of resistance and friction as normally existing in an in-order stem. Also in this case, at least a first type of alert is issued, and in some cases also a second type of alert is issued as well. It should be noted that although in this case, the failure in fact was occurred within the stem, and not within the actuator itself, still this failure is referred to herein as “actuator failure”, for the sake of convenience.
c. Completion of the path slower than expected: In this case, although the actuator has fully performed its task, the fact that the completion of the path has reached slower than expected, results in at least a first type of alert.
d. Irregular angular progression: In this case, although the completion of the task is reached, and the whole path is completed within the nominal period, still a detection of irregular partial progression within the entire path is made, which hints to an initial stage of development of actuator failure. In that case, a second type of alert is issued.

It has been found that the system of WO 2008/078323 can be easily upgraded to perform the task of the present invention, in addition to the original tasks as described in WO 2008/078323. The system of WO 2008/078323 in fact essentially comprises all the hardware elements that are required for this upgraded purpose. More specifically, said system of WO 2008/078323 comprises a processor, a sensor for sensing the angular position, and communication means for conveying data to the control center. Beyond these, the required modifications for adapting the system of WO 2008/078323, particularly the VMD of said system to perform the tasks of the present invention, are essentially only software modifications.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. System for determining a potential future failure of an actuator or valve that together control a fluid flow in a line, said control determines a rate of flow in the line by the actuator which in turn causes angular change to a stem of said valve between two respective valve states, the system comprises:
a. a sensor for continuously sensing the angular orientation of the stem upon any angular change to said stem as caused by said actuator, and for conveying to a monitoring unit a respective angular variation signal; and
b. a monitoring unit which comprises:
i. a local storage for storing nominal transitional values for said pair of actuator and valve;
ii. a sampling unit for receiving said angular variation signal, and producing a transition vector which comprises periodical samples from said signal; and
iii. a local comparator unit for: (a) comparing at least a portion of said transitional vector with a corresponding set from said stored nominal transitional values; and (b) if a difference above one or more predefined threshold values is determined, issuing an alert for a potential failure of said actuator.

2. The system according to claim 1, wherein said comparison of at least a portion of said transitional vector relates to the total period for transition between said two valve states, and wherein if a difference above a predefined threshold value is determined for this total period following said comparison, a first type of alert is issued.

3. The system according to claim 1, wherein the transitional vector is conveyed to the control center, which in turn comprises:
i. a remote storage for storing full-vector nominal transitional values for said pair of actuator and valve; and
ii. a remote comparator for comparing periodical samples from said transitional vector with corresponding stored nominal transitional values, and if a difference above one or more predefined threshold values is determined for one or more of the periodical samples, issuing a second type alert for a potential failure of said actuator.

4. System according to claim 1, which further comprises storage for said threshold values.

5. System according to claim 3, which further comprises storage for said threshold values.

6. System according to claim 1, wherein said comparator is made of plurality of comparator elements.

7. System according to claim 3 wherein said comparator is made of plurality of comparator elements.

8. A method for predicting a failure in an actuator for a quarter turn valve, which comprises:
a. storing nominal transitional values describing the rate of angular change of a stem of said quarter turn valve during activation by said actuator;
b. upon activation of the quarter turn valve by said actuator, obtaining a transitional vector which describes the rate of angular change of said stem during activation; and
c. comparing said transitional vector with at least a portion of said nominal transitional values, and when determining a difference above a predefined value, concluding that a failure exists or is expected to occur.
